(19) United States
(12) Patent Application Publication
(10) Pub. No.: US 2005/0109807 A1
(43) Pub. Date: May 26, 2005

(54) Retract - collapsible rack system for bed of every existing pick - up truck

(76) Inventor: Rodrigo Corral, San Juan, PR (US)

Correspondence Address: RODRIGO CORRAL;Apt 8. A, KINGS COURT # 52, SAN JUAN, PR, 00911, US

(21) Appl. No.: 10/720,048

(22) Filed: Nov. 25, 2003

(51) Int. Cl. B60R 7/00; B60R 9/00

(52) U.S. Cl. 224/403

(57) ABSTRACT

When collapsed it will lie flat on bed of truck, when retracted it will create an “X” like Figure, from floor of bed to roof base of cabin of truck. The “X’ consists of (5) five joint each can move to make X higher or lower depending on the height from floor of bed o roof top of cabin. The materials used will be light metal alloys to permit lightness yet strength. When collapsed it will not occupy any room in bed space, when retracted it will allow objects bigger than bed to be carried on top of roof of cabin extending on top of “X” figure.

RETRACT—is a collapsible track that lies flat on the pick up bed. It is used by expanding it, with a similar mechanism used in the collapsible legs of an ironing board. When you expand it it will be in level with the roof of the pick-up truck passenger cabin, thus allowing to transport any material or object that will not fit the length space of the bed. This will prevent the object to protrude outside the gate of the bed and cause a hazard.

The collapsible track can be made of light weight aluminum or any other similar light weight and sturdy alloy.

It's installation is to the bed of the pick-up truck and when collapsed it will lay flat so it wont disturb with the cargo area of the truck.

1. I Rodrigo Corral claim to have invented RETRACK a collapsible rack which fits in the bed of every existing pick up. it will lay flat on the bed until it is ready for use, at which time it can be lifted to level the cabin roof and be used to carry materials, that otherwise, would have not fitted in the bed.
